(19) United States
(12) Patent Application Publication
(10) Pub. No.: US 2005/0044844 A1
(43) Pub. Date: Mar. 3, 2005

(54) Upgraded emissions reduction system

(76) Inventors: Lester P. Berriman, Irvine, CA (US); Lionel S. Simons, Dana Point, CA (US); John M. Zabsky, Santa Ana, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 10/918,569

(22) Filed: Aug. 13, 2004

Related U.S. Application Data
(60) Provisional application No. 60/498,766, filed on Aug. 29, 2003.

(51) Int. Cl. F01N 3/10; F01N 3/00; C01B 21/00; B01J 8/00

(52) U.S. Cl. 60/286; 60/301; 60/297; 60/295

(57) ABSTRACT

A system is provided that reduces nitrogen oxides in the exhaust gases of an engine by converting nitric oxide (NO) in the exhaust gases to nitrogen dioxide (NO₂) prior to injecting ammonia (NH₃) into the exhaust gases, and then passing the exhaust gases through a vehicle catalytic converter. Much of the nitric oxide (NO) is converted to nitrogen dioxide (NO₂) by passing the exhaust gases first through a catalyzed particulate filter (CPF) such as one containing a nitric oxide catalyst. In cases where the exhaust gases must pass from the exhaust gas manifold through an exhaust conduit portion of a length of at least one-eighth meter before reaching the catalyzed particulate filter, that exhaust conduit portion is heavily insulated to result in a high exhaust gas temperature at the downstream end of that conduit portion by at least 30° C. over the temperature without insulation.

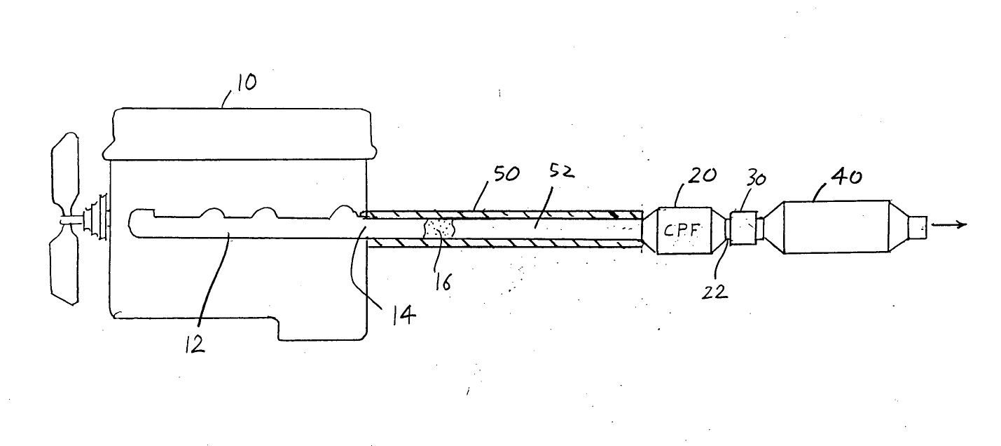

### CROSS REFERENCE

Applicant claims priority from U.S. provisional application Ser. No. 60/498,766 filed Aug. 29, 2003.

### BACKGROUND OF THE INVENTION

Our earlier U.S. Pat. No. 5,992,141 describes the injection of activated ammonia into hot exhaust gases of vehicle engines, to reduce nitrogen oxides (NO and NO₂) which are sometimes referred to as NOX and which is a major component of smog. The injected ammonia (NH₃) reacts with nitrogen oxides (NO and NO₂) in the exhaust gases to produce nitrogen and water vapor. While the system described in the above patent reduces nitrogen oxides, some nitrogen oxides are still present in the exhaust gases that are released into the atmosphere. More stringent air quality standards require that the amount of nitrogen oxides be reduced even further.

### SUMMARY OF THE INVENTION

In accordance with one embodiment of the present invention, applicant further reduces nitrogen oxides in the exhaust gases of vehicle engines that are already reduced by the injection of ammonia and its components into the exhaust gases. The further reduction is achieved by converting a maximum portion of the nitric oxide (NO) in the exhaust gases into nitrogen dioxide (NO₂). The injected ammonia and ammonia components react catalytically much faster and more completely with nitrogen dioxide (NO₂) than with nitric oxide (NO), resulting in less nitrogen oxides released into the atmosphere.

The conversion of nitric oxide (NO) to nitrogen dioxide (NO₂) is achieved by placing a catalyzed particulate filter, containing a nitric oxide catalyst such as the Sud-Chemic Prototech proprietary catalyst, between the exhaust manifold of the engine and the injection station where ammonia and its components are injected into the exhaust gas stream. This allows the injected ammonia to react with a high concentration of nitrogen dioxide (NO₂). The ammonia injection station is generally followed by a NOxMASTER SCR/DOC catalytic converter, sold by KleenAir Systems, Inc. of Irvine, Calif., which is provided primarily to promote the reaction of ammonia with nitrogen oxides and the conversion of carbon and carbon monoxide into carbon dioxide.

In some vehicles such as diesel buses, there is no room to place a catalyzed particulate filter (CPF) at the end of the exhaust gas manifold except at least about a meter rearward of the manifold. Previously, this resulted in a large temperature drop of the exhaust gases before they reached the first catalyst, and an even further drop before the exhaust gases reach applicant's ammonia injector station. Applicant mitigates this by wrapping insulation about the exhaust gas conduit portion that extends between the exhaust gas manifold and the long (at least about a meter, but even if one-eighth meter long) conduit portion. The insulation reduces the temperature drop so the temperature is at least 30° C. higher than the temperature that would exist in the absence of such insulation.

The novel features of the invention are set forth with particularity in the appended claims. The invention will be best understood from the following description when read in conjunction with the accompanying drawings.

### BRIEF DESCRIPTION OF THE DRAWINGS

The FIGURE illustrates a diesel engine assembly of a type wherein there is a long exhaust gas conduit portion immediately downstream of the exhaust gas manifold, and that includes applicants' invention.

### DESCRIPTION OF THE PREFERRED EMBODIMENTS

The FIGURE illustrates a diesel engine 10 with an exhaust manifold 12 that combines the exhaust from all engine cylinders and passes the exhaust gases 16 from the manifold outlet 14 through a conduit 52. The exhaust gases pass through a CPF (catalyzed particulate filter) 20, through an ammonia injection station 30, and through a catalytic converter 40. The catalytic converter is preferably a NOxMASTER SCR/DOC catalytic converter. The catalyst in the catalytic converter helps react ammonia (NH₃) with nitrogen oxides in the exhaust gasses. It also reacts oxygen with carbon and carbon monoxide in the exhaust gases to reduce unburned carbon particles and produce carbon dioxide.

Applicant's experiments show that ammonia (NH₃) and ammonia components (NH₂ and/or NH+H) react much faster and more completely with nitrogen dioxide (NO₂) than with nitric oxide (NO). Applicant also finds that the CPF (catalyzed particulate filter) 20, which is used to reduce soot in diesel engine exhaust gases, has another use. It converts a considerable portion of the nitric oxide (NO) present in exhaust gases to nitrogen dioxide (NO₂) (using oxygen in the exhaust gases) as well as reducing other undesirable emissions. One model of CPF, which includes a proprietary catalyst, is the Prototech from Sud-Chemic of Needham, Mass., which includes platinum (25 g/cf) and Mg₃(NO₄)₂ (400 g/cf) which is deposited onto a Corning cordierite wall flow filter, which has been found to be effective. Another is available as the “DPX Catalyzed Diesel Soot Filter” from Englehard Corporation of Iselin, N.J. These CPF's include nitric oxide catalysts that are efficient in converting NO to NO₂. Platinum alone is a fair catalyst for oxidizing nitric oxide (NO) to convert it to nitrogen dioxide (NO₂).

Applicant has measured the effects of the above CPF's in converting nitric oxide (NO) to nitrogen dioxide (NO₂). Applicant measured 30% NO and 70% NO₂ at the location 22 immediately downstream of the CPF. This is a considerable improvement over the original 90% NO and 10% NO₂ at the exhaust gas manifold outlet 14. The nitric oxide catalyst in the CPF should convert at least one-fourth of the mass of nitric oxide to nitrogen dioxide (NO₂) to allow the ammonia to reduce nitrogen oxides significantly more (at least a 10% further reduction) than without the CPF. In the above tests, the percent of nitric oxide (NO) of the total of all nitrogen oxides fell by at least 10% and the percent of nitrogen dioxide rose by at least 10% prior to the gases reaching the ammonia injection station 30.

A DOC (diesel oxidizing catalyst, not illustrated) is commonly placed between a diesel engine exhaust manifold and a particle filter. This can be perhaps followed by urea injection, and finally followed by SCR (selective catalyst reduction) similar to that shown at 40 in the FIGURE. However, this results in a separate particle filter downstream of the DOC. The DOC converts some of the NO to NO₂, but the use of a separate filter downstream of the DOC constitutes an extra part to be used. Also, the temperature of the exhaust gases decrease more in passage through a DOC and then through a conduit connection and then through a particle filter, than when passing only through the catalyzed particle filter 20.

It is desirable that the exhaust gas temperature remain as high as possible (though no higher than the temperature in the exhaust manifold) when it passes through the CPF (catalyzed particle filter) 20, to maximize the conversion of nitric oxide (NO) to nitrogen dioxide (NO₂). Applicant has examined the constructions of a variety of diesel engine-powered vehicles, particularly in England. Applicant found that in taxicab vehicles the DOC (diesel oxidizing catalyst) and filter were close, with the DOC within three inches of the exhaust manifold outlet. However, in British diesel buses and most diesel buses encountered in the United States, there is a separation of typically 4 to 6 feet between the manifold and DOC because there is no room in the buses to place the DOC closer to the manifold. Any substantial distance such as more than one-eighth meter (5 inches), along an ordinary exhaust gas conduit portion extending between the exhaust manifold outlet and the catalyst that converts NO to NO₂, results in a significant reduction in such conversion.

When the distance between the exhaust manifold outlet and the DOC or applicant's CPF (catalyzed particulate filter) is more than one-eighth meter and especially if it is more than one-quarter meter, applicant applies heavy insulation to the conduit to minimize the fall in temperature of the exhaust gases therealong. Applicant has applied a high level of insulation 50 around the conduit portion that extends between the manifold outlet and the CPF's in such buses. Sufficient insulation was applied that the temperature of the CPF and the exhaust gases therein dropped to only 420° C., instead of to 350° C. that occurred without insulation, resulting in much more effective conversion of nitric oxide (NO) to nitrogen dioxide (NO₂) by the CPF. The insulation reduced the temperature drop (to 420° C. instead of 350° C.) by 70° C., which is a 20% increase in temperature in degrees centigrade. An increase of at least 30° C. is a significant improvement.

The FIGURE shows the insulation at 50 which covers the conduit portion 52 leading from the manifold outlet 14 to the CPF (catalyzed particulate filter) 20. Applicant prefers an insulator based on carbon fibers sold as the Carbon-Guard by Carbon Cloth Technologies, Inc., a wholly-owned subsidiary of KleenAir Systems, Inc. of Irvine, Calif. Applicant provides sufficient insulation to increase the temperature at the downstream end of the exhaust gas conduit at least 30° C. and by at least 10% (as measured in degrees Centigrade), as from 350° C. to over 420° C.

Some advantages of applicant's arrangement in which the CPF with nitric oxide catalyst is placed immediately downstream of the engine exhaust manifold (less than 5 inches or well insulated if more) are that applicant avoids the requirement for both a DOC (diesel oxidizing catalyst) and a filter, by replacing the two parts with a single part which is the catalyzed particulate filter (CPF) 20. In addition, the exhaust gases are considerably hotter than those that have passed along the extra length of both a DOC and filter and the coupling between them, especially if there is no insulation. Applicant's ammonia injection apparatus has progressively greater efficiency when the exhaust gases that the ammonia (and/or constituents of ammonia) is injected into, are of progressively higher temperatures (but below the manifold temperature). The insulation of the exhaust gas conduit portion between the manifold and the DOC or CPF, especially if it is over 5 inches (one-eighth meter) long makes for more efficient NOX reduction by ammonia injection, especially when a CPF is used.

While applicant has discussed the reduction of NOX (nitrogen oxides), other unwanted emissions (CO, CO₂ and other hydrocarbons and particles) are also reduced more effectively by applicant's system. As mentioned, applicant's system includes a catalyzed particulate filter to catalyze exhaust gases by converting nitric oxide (NO) to nitrogen dioxide (NO₂), and to remove particles, and applicant may apply high temperature insulation around the conduit leading to the catalyzed particulate filter to increase the exhaust gas temperature thereat and thereby produce greater catalyzing efficiency.

Thus, applicant enables more effective reduction of nitrogen oxides by injecting ammonia and its components into an exhaust gas conduit in which a considerable portion (more that 20%) of the nitric oxide (NO) component of nitrogen oxides in the exhaust gases are converted into nitrogen dioxide (NO₂). Instead of placing the ammonia injection station downstream of a DOC (diesel oxidizing catalyst) that is followed by a coupling leading to a particulate filter, applicant places the ammonia injection station immediately downstream of a CPF (catalyzed particle filter). The CPF includes a nitric oxide catalyst that converts NO to NO₂, and combines the functions of a DOC and particulate filter while increasing gas temperature for more efficient nitrogen oxide reduction by ammonia injection.

Although particular embodiments of the invention have been described and illustrated herein, it is recognized that modifications and variations may readily occur to those skilled in the art, and consequently, it is intended that the claims be interpreted to cover such modifications and equivalents.

1. Apparatus for the more efficient reduction of nitrogen oxides in the exhaust gases of a diesel engine in which said exhaust gases flow downstream from the exhaust manifold outlet along a conduit to the atmosphere, wherein the exhaust gases include nitric oxide (NO) and nitrogen dioxide (NO₂), and wherein the apparatus includes an ammonia injection station located along the conduit where ammonia and its components are injected into the conduit, including:
a nitric oxide catalyst that lies along said conduit and that converts at least one-fourth of the nitric oxide (NO) to nitrogen dioxide (NO₂).

2. The apparatus described in claim 1 wherein:
said ammonia injection station lies downstream from said nitric oxide catalyst, whereby injected ammonia is injected into exhaust gas with a high proportion of nitrogen dioxide (NO₂).

3. The apparatus described in claim 2 including:
a catalytic converter that lies downstream of said ammonia injection station.

4. The apparatus described in claim 1 wherein:
said nitric oxide catalyst is part of a catalyzed particulate filter that includes a particulate filter.

5. Apparatus for the more efficient reduction of nitrogen oxides in the exhaust gas of a diesel engine, by the injection of ammonia (NH₃) and its components into the exhaust gas, including:
a catalyzed particulate filter lying in the path of exhaust gases from the engine which includes a catalyst that accelerates the conversion of a portion of nitric oxide (NO) in the exhaust gases into nitrogen dioxide (NO₂), so as to produce an enhanced proportion of NO₂, and a particulate filter;
an ammonia injector that lies downstream of said catalyzed particulate filter, to inject ammonia (NH₃) and its component into the exhaust gases that now contain an enhanced portion of nitrogen dioxide;
a selective catalyzing reduction catalyst that lies down stream of said injector, that passes the exhaust gasses with an enhanced portion of nitrogen dioxide and with ammonia injected therein, to react the nitrogen dioxide with ammonia before the exhaust gasses are released into the atmosphere.

6. The apparatus described in claim 5 wherein said engine has an exhaust manifold and has a gas conduit of a length of at least one-quarter meter between a downstream end of said exhaust manifold and said catalyzed particulate filter, including;
a wrapping of thermal insulation extending around said gas conduit, which is sufficiently thermally insulative to raise the temperature of the exhaust gasses at said catalyzed particulate filter by at least 30° C. compared to the temperature thereat in the absence of said thermal insulation.

7. A method for the more efficient reduction of nitrogen oxides in the exhaust gases of a diesel engine that flow downstream from the engine exhaust manifold along a conduit past an ammonia injection station where ammonia and its components are injected into the exhaust gases, including:
passing exhaust gases from the exhaust manifold, through a nitric oxide catalyst and reducing the percent of nitric acid (NO) of the total of all nitrogen oxides in the exhaust gases by at least 10% and to increase the percent of nitrogen dioxide (NO₂) of the total nitrogen oxides in the exhaust gases by at least 10%.

8. The method described in claim 7 wherein:
said step of passing exhaust gases through a nitric oxide catalyst includes passing said gases through said catalyst before the gases pass through said ammonia injection station.

9. The method described in claim 7 including:
insulating the portion of said conduit that extends between said exhaust manifold and said nitric oxide catalyst to raise the temperature of the gases at said catalyst by at least 30° C. over the temperature that exists in the absence of the insulation.

10. A method for the effective reduction of nitrogen oxides in the exhaust gases of an engine by the injection of ammonia (NH₃) and its components into the exhaust gases, including:
passing exhaust gases from the engine through a catalyzed particulate filter that includes a catalyst that accelerates the conversion of a portion of the nitric oxide (NO) in the exhaust gases into nitrogen dioxide (NO₂), so as to increase the proportion of NO₂ and decrease the proportion of NO in the exhaust gas, each by at least 10%;
injecting ammonia (NH₃) and its components into exhaust gases that have passed through the catalyzed particulate filter;
passing the exhaust gasses into which ammonia and its components have been injected, through a final catalyst that reacts ammonia components with NO₂ to produce nitrogen and water.

11. The method described in claim 10 wherein the gases from the engine pass through a conduit portion of a length of at least one-eighth meter in moving from an engine exhaust manifold outlet to the particulate filter, including:
insulating said conduit portion from the environment so the temperature of the exhaust gases entering the catalyzed particulate filter has a temperature at least 30° C. higher than if the conduit portion was not insulated.
